(19) United States
(12) Patent Application Publication
(10) Pub. No.: US 2008/0107335 A1
(43) Pub. Date: May 8, 2008

(54) METHODS FOR PROCESSING IMAGE SIGNALS AND RELATED APPARATUS

(76) Inventors: Po-Wei Chao, Taipei Hsien (TW); Chun-Hsing Hsieh, Hsin-Chu City (TW); Wen-Tsai Liao, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/845,738

(22) Filed: Aug. 27, 2007

(30) Foreign Application Priority Data
Nov. 7, 2006 (TW) 095141155

(51) Int. Cl. G06K 9/34

(52) U.S. Cl. 382/173

(57) ABSTRACT

The present invention provides methods for processing image signals, methods for displaying image signals, and related apparatus. One of the proposed methods includes: performing a predetermined detection on an image signal; partitioning a picture corresponding to the image signal into a plurality of image regions wherein each image region has a plurality of pixels; and computing statistic data for each of the plurality of image regions according to results of the predetermined detection to obtain a plurality of statistic data corresponding to the plurality of image regions.

### BACKGROUND OF THE INVENTION

1. Field of the Invention

The present invention relates to image processing techniques, and more particularly, to a method for processing image signals, an image display method and apparatus thereof.

2. Description of the Prior Art

In the prior art, image signal processing, such as calculating, performing statistics upon or analyzing the motion magnitude, or pixel distribution of an image, is usually performed in a unit of a field or a frame. However, when processing said image in a unit of a field or a frame, differences between areas in the image are difficult to taken into consideration, which causes low image quality.

For example, many conventional display devices add extra image data, such as a caption or a logo, in the video signal before displaying the video signal. Such extra image data are only shown in certain local areas of the video picture. If de-interlacing processing is performed on the video signal in a unit of a field or a frame, a flicker or jagged phenomenon will occur on the caption or the logo. Accordingly, image processing performed in a unit of a field or a frame cannot satisfy the requirement for high image quality.

### SUMMARY OF THE INVENTION

It is therefore one of the objectives of the present invention to provide a method for processing image signals, an image display method and apparatus thereof, to solve the above-mentioned problem.

According to an exemplary embodiment of the present invention, a method for processing image signals is disclosed. The method comprises performing a predetermined detection on an image signal; partitioning a picture corresponding to the image signal into a plurality of image regions wherein each image region comprises a plurality of pixels; and computing statistic data for each of the image regions according to results of the predetermined detection to obtain a plurality of statistic data corresponding to the image regions.

According to an exemplary embodiment of the present invention, an apparatus for processing image signals is also disclosed. The apparatus comprises: a detector, for performing a predetermined detection on an image signal; a determining unit, for partitioning a picture corresponding to the image signal into a plurality of image regions wherein each image region comprises a plurality of pixels; and a computing unit, coupled to the detector and the determining unit, for computing statistic data for each of the image regions according to results of the predetermined detection to obtain a plurality of statistic data corresponding to the image regions.

According to an exemplary embodiment of the present invention, an image display method is disclosed. The image display method comprises: performing a predetermined detection on an image signal; partitioning a picture corresponding to the image signal into a plurality of image regions wherein each image region comprises a plurality of pixels; computing statistic data for each of the image regions according to results of the predetermined detection to obtain a plurality of statistic data corresponding to the image regions; utilizing a display apparatus having a backlight module to display the picture; and controlling a portion of the backlight module corresponding to a specific image region according to statistic data for the specific image region of the image regions.

According to an exemplary embodiment of the present invention, an image display system is disclosed. The image display system comprises: a detector, for performing a predetermined detection on an image signal; a determining unit, for partitioning a picture corresponding to the image signal into a plurality of image regions wherein each image region comprises a plurality of pixels; a computing unit, coupled to the detector and the determining unit, for computing statistic data for each of the image regions according to results of the predetermined detection to obtain a plurality of statistic data corresponding to the image regions; a display apparatus, having a backlight module, for displaying the picture; and a controlling unit, coupled to the computing unit and the backlight module, for controlling a portion of the backlight module corresponding to a specific image region according to statistic data for the specific image region of the image regions.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified block diagram illustrating an image signal processing apparatus according to an embodiment of the present invention

FIG. 2 is a flow chart illustrating a method for processing image signals according to an embodiment of the present invention.

FIG. 3 is a diagram illustrating some embodiments for partitioning a picture according to the present invention.

FIG. 4 is a simplified block diagram illustrating an image display system according to an embodiment of the present invention.

FIG. 5 is a flow chart illustrating an image display method according to an embodiment of the present invention.

### DETAILED DESCRIPTION

Different features of the present invention are detailed as below in reference to the figures, and for convenience of explanation, the same elements in separate figures are indicated by the same reference numerals.

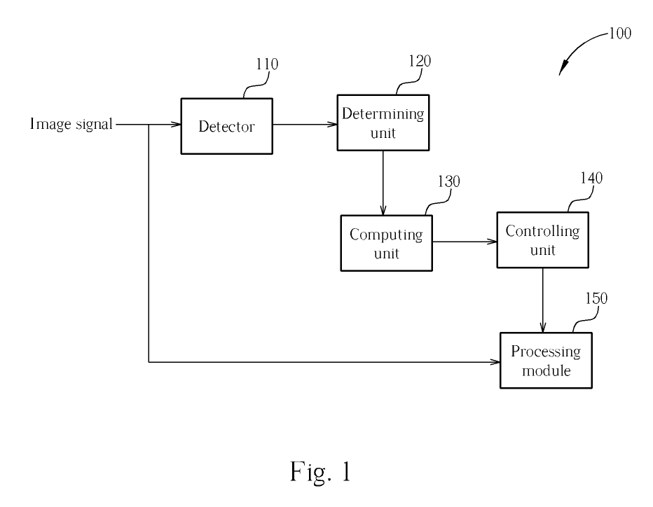

Please refer to FIG. 1. FIG. 1 is a block diagram illustrating an image signal processing apparatus 100 according to an embodiment of the present invention. In this embodiment, the image signal processing apparatus 100 includes a detector 110, a determining unit 120, a computing unit 130, a controlling unit 140 and a processing module 150. In practice, every functional block of the image signal processing apparatus 100 can be implemented respectively by different circuit components or by integrating a portion or all of the functional blocks of the image signal processing apparatus 100 in a single chip. In addition, the function can also be implemented by a microprocessor with well-designed program execution codes.

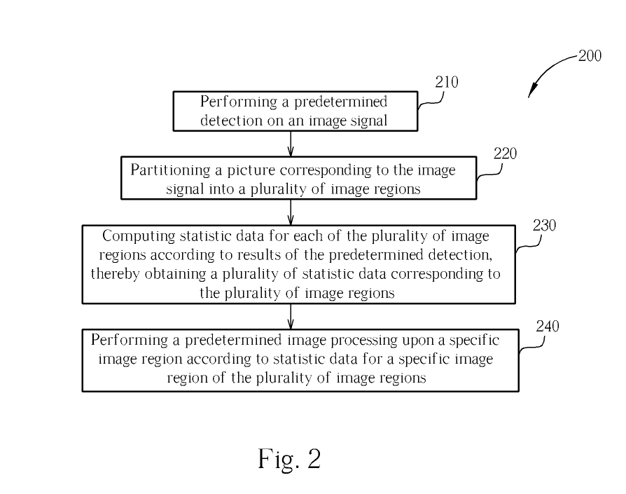

FIG. 2 is a flow chart 200 illustrating a method for processing image signals according to an embodiment of the present invention. Referring to the flow chart 200 shown in FIG. 2, further description of the operation of the image signal processing apparatus 100 is as follows.

In step 210, the detector 110 performs a predetermined detection on an image signal received by the image signal processing apparatus 100. In practice, the type and content of the predetermined detection can be designed depending on the practical requirements, and are not limited to particular embodiments. For example, the detector 110 can detect pixel values of the pixels in the image signal or the noise of the image signal. The pixel value stated in the disclosure can be luminance value, chrominance value or gray level; however, this is not meant to be a limitation of the present invention. The detector 110 can also perform motion detection upon every pixel of the image signal to compute motion value of every pixel, or to determine if any pixel corresponds to a still image. The above-mentioned motion detection performed by the detector 110 can be field motion detection, frame motion detection or both.

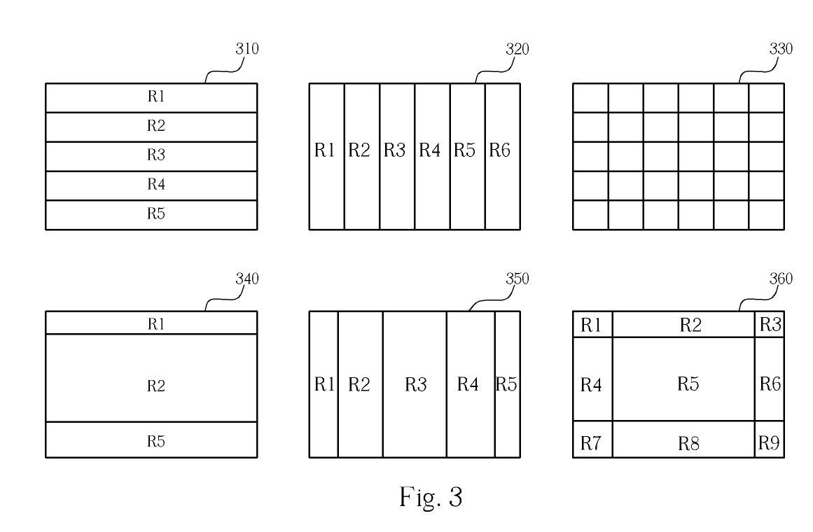

In step 220, the determining unit 120 partitions a picture corresponding to the image signal into a plurality of image regions in which each image region has a plurality of pixels. For example, some exemplary methods of partitioning the picture are shown in FIG. 3. In the exemplary method 310 of FIG. 3, the picture is vertically and averagely partitioned into 5 image regions R1˜R5; in the exemplary method 320 of FIG. 3, the picture is horizontally and averagely partitioned into 6 image regions R1˜R6; in the exemplary method 330 of FIG. 3, the picture is averagely partitioned into 6*5=30 image regions. In practice, the size and shape of the image regions are not limited to being the same. For example, in the exemplary method 340 of FIG. 3, the picture is vertically partitioned into 3 unequal image regions R1˜R3; in the exemplary method 350 of FIG. 3, the picture is horizontally partitioned into 5 unequal image regions R1˜R5; in the exemplary method 360 of FIG. 3, the picture is partitioned into 3*3=9 unequal image regions.

Please note that the exemplary methods shown in FIG. 3 are merely for illustrative purposes, and are not meant to be limitations of the present invention. In particular, the region shape partitioned by the determining unit 120 is not limited to be rectangular, and the means of partitioning the picture can be adjusted dynamically with the practical image contents of the picture. For example, in one embodiment, the determining unit 120 partitions the picture into a plurality of image regions according to results of the predetermined detection so as to make the pixels in the same region have similar results of the predetermined detection. For instance, the determining unit 120 can classify the picture into still image region(s) and motion image region(s). Also, the determining unit 120 can classify the picture into high luminance image region(s) and low luminance image region(s).

Next, in step 230, the computing unit 130 computes statistic data for each of the plurality of image regions according to results of the predetermined detection, thereby obtaining a plurality of statistic data corresponding to the plurality of image regions. For example, the computing unit 130 can compute the average pixel value of the pixels, the total number of the pixels with motion, the sum of the motion values of the pixels, noise magnitude, luminance distribution, or chrominance distribution, etc. for each of the plurality of image regions. The statistic data given by the computing unit 130 is related to the predetermined detection performed by the detector 110 in step 210.

In step 240, the controlling unit 140 performs a predetermined image processing upon a specific image region according to statistic data for a specific image region of the plurality of image regions. Please note that the “predetermined image processing” indicated here includes all kinds of image processing operations capable of adjusting related processing parameters according to the statistic data, such as de-interlacing processing, Y/C separation processing, false color suppression, noise reduction, color processing, and so on. In addition, the predetermined image processing further includes error correction operation, smoothing operation or edge enhancement operation, as disclosed in Taiwan Patent No. 1248759, entitled “image processing method and related apparatus thereof”.

For example, provided that the processing module 150 includes a de-interlacing device, the controlling unit 140 controls the de-interlacing device to perform de-interlacing processing on the specific image region according to the total number of pixels with motion in the specific image region. In this embodiment, when the total number of pixels with motion of the specific image region is less than a first threshold value, the controlling unit 140 will command the de-interlacing device to perform de-interlacing processing on the specific image region by making use of inter-field interpolation. On the other hand, when the total number of pixels with motion of the specific image region is not less than the first threshold value, the controlling unit 140 will command the de-interlacing device to perform de-interlacing processing on the specific image region by making use of intra-field interpolation. Both inter-field interpolation and introduce intra-field interpolation are well known, so further description is not detailed here for the sake of brevity.

Since the controlling unit 140 and the processing module 150 perform the corresponding de-interlacing processing on the plurality of image regions respectively according to the plurality of statistic data, the occurrence of flicker or jagged phenomenon on the caption or the logo in the prior art can be reduced greatly and high image quality can be obtained accordingly.

Provided that the processing module 150 further comprises a Y/C separation device, the controlling unit 140 controls the Y/C separation device to perform Y/C separation processing on the specific image region according to the total number of pixels with motion in the specific image region. For example, when the total number of pixels with motion of the specific image region is less than a second threshold value, the controlling unit 140 will control the Y/C separation device to perform Y/C separation processing on the specific image region by making use of 3D comb filtering. On the other hand, when the total number of pixels with motion of the specific image region is no less than the second threshold value, the controlling unit 140 will control the Y/C separation device to perform Y/C separation processing on the specific image region by making use of 1D/2D comb filtering.

It should be noted that the execution order of steps in flow chart 200 is merely an embodiment rather than a restriction of the practical implementation. For example, the execution order of step 210 and 220 can be exchanged.

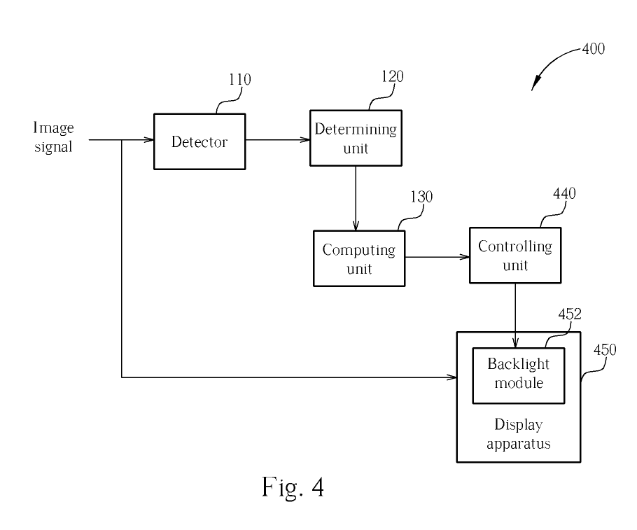

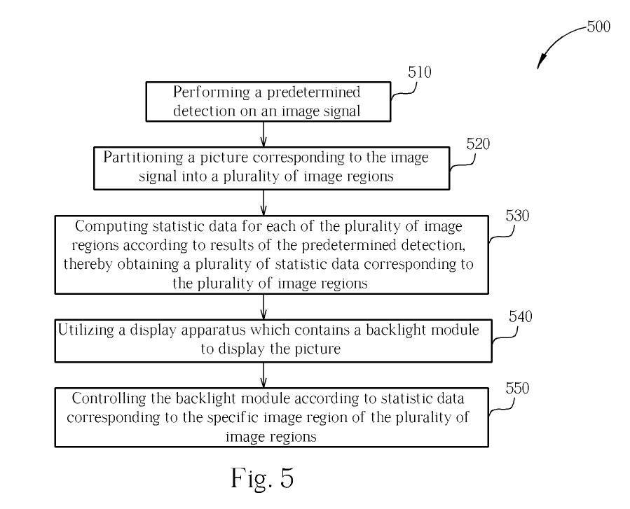

In practice, the concept of computing statistic data by partitioned image regions can also be applied to image display fields. Please refer to FIG. 4 and FIG. 5. FIG. 4 is a simplified block diagram illustrating an image display system 400 according to an embodiment of the present invention. FIG. 5 is a flow chart 500 illustrating an image display method according to an embodiment of the present invention. Similar to the above-mentioned image signal processing apparatus 100, the image display system 400 also includes a detector 110, a determining unit 120 and a computing unit 130. In this embodiment, the image display system 400 further includes a controlling unit 440 and a display apparatus 450 having a backlight module 452. In practice, the display apparatus 450 can be a liquid crystal display (LCD) panel, an LCD monitor or an LCD television. In this embodiment, the backlight module 452 in the display apparatus 450 includes a plurality of lamps, e.g. cold cathode fluorescent lamps (CCFL), a plurality of light emitting diodes (LED), or any combinations thereof. Referring to the flow chart 500 shown in FIG. 5, further description for the operation of the image display system 400 is as follows.

Since the operation of the detector 110, the determining unit 120 and the computing unit 130 in steps 510, 520 and 530 are the same as the operation of those same functional blocks in steps 210, 220 and 230 respectively, further description is omitted here for brevity.

In step 540, the image display system 400 utilizes the display apparatus 450, which contains the backlight module 452, to display the picture corresponding to the image signal.

In step 550, the controlling unit 440 controls the backlight module 452 according to statistic data corresponding to the specific image region of the plurality of image regions that are partitioned by the determining unit 120. For example, the controlling unit 440 can control the driving voltage/current of CCFL or LED corresponding to the specific image region according to the average luminance of the pixels in the specific image region.

In one embodiment, when the average luminance of the pixels in the specific image region is less than a first predetermined value, the controlling unit 440 will reduce the driving voltage/current of CCFL or LED corresponding to the specific image region in order to decrease the luminance of CCFL or LED. On the other hand, when the average luminance of the pixels in the specific image region is greater than a second predetermined value, the controlling unit 440 will raise the driving voltage/current of CCFL or LED corresponding to the specific image region in order to increase the luminance of CCFL or LED. In this way, the contrast between the brighter image region and darker image region in the picture displayed by the display apparatus 450 can be enhanced at once. In other words, this increases the response speed to the change of the luminance of the display apparatus 450.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for processing image signals, comprising:
performing a predetermined detection on an image signal;
partitioning a picture corresponding to the image signal into a plurality of image regions wherein each image region comprises a plurality of pixels; and
computing statistic data for each of the image regions according to results of the predetermined detection to obtain a plurality of statistic data corresponding to the image regions.

2. The method of claim 1, wherein the image regions are partitioned according to the results of the predetermined detection.
partitioning the picture into M*N image regions, wherein both M and N are greater than 1.

3. The method of claim 1, wherein the step of performing the predetermined detection on the image signal comprises:
detecting the pixel values of pixels in the image signals.

4. The method of claim 1, wherein the step of performing the predetermined detection on the image signal comprises:
performing motion detection upon a pixel of the image signal to determine if the pixel corresponds to a still image.

5. The method of claim 1, wherein the step of performing the predetermined detection on the image signal further comprises:
performing motion detection upon a pixel of the image signal to obtain a motion value of the pixel.

6. The method of claim 1, wherein the predetermined detection is performed pixel by pixel.

7. The method of claim 1, wherein the step of performing the predetermined detection on the image signal comprises:
detecting noise of the image signal.

8. The method of claim 1, further comprising:
performing a predetermined image processing upon a specific image region of the image regions according to statistic data corresponding to the specific image region of the image regions.

9. The method of claim 8, wherein the predetermined image processing is selected from a group composing de-interlacing processing, noise reduction, color processing, Y/C separation processing, false color suppression, error correction operation, smoothing operation and edge enhancement operation.

10. An apparatus for processing image signals, comprising:
a detector, for performing a predetermined detection on an image signal;
a determining unit, for partitioning a picture corresponding to the image signal into a plurality of image regions wherein each image region comprises a plurality of pixels; and
a computing unit, coupled to the detector and the determining unit, for computing statistic data for each of the image regions according to results of the predetermined detection to obtain a plurality of statistic data corresponding to the image regions.

11. The apparatus of claim 10, wherein the determining unit partitions the image regions according to the results of the predetermined detection.

12. The apparatus of claim 10, wherein the detector detects the pixel values of the pixels of the image signals.

13. The apparatus of claim 10, wherein the detector performs motion detection upon a pixel of the image signal to determine if the pixel corresponds to a still image.

14. The apparatus of claim 10, wherein the detector performs motion detection upon a pixel of the image signal to compute motion value of the pixel.

15. The apparatus of claim 10, wherein the detector performs the predetermined detection pixel by pixel.

16. The apparatus of claim 10, wherein the detector detects noise of the image signal.

17. The apparatus of claim 10, further comprising:
a processing module; and
a controlling unit, coupled to the computing unit and the processing module, for performing a predetermined image processing upon a specific image region according to statistic data for the specific image region of the image regions.

18. The apparatus of claim 17, wherein the predetermined image processing is selected from a group comprising de-interlacing processing, noise reduction, color processing, Y/C separation processing, false color suppression, error correction operation, smoothing operation and edge enhancement operation.

19. An image display method, comprising:
performing a predetermined detection on an image signal;
partitioning a picture corresponding to the image signal into a plurality of image regions in which each image region has a plurality of pixels;
computing statistic data for each of the image regions according to results of the predetermined detection to obtain a plurality of statistic data corresponding to the image regions;
utilizing a display apparatus having a backlight module to display the picture; and
controlling a portion of the backlight module corresponding to a specific image region according to statistic data for the specific image region of the image regions.

20. The image display method of claim 19, wherein the image regions are partitioned according to the results of the predetermined detection.

21. An image display system, comprising:
a detector, for performing a predetermined detection on an image signal;
a determining unit, for partitioning a picture corresponding to the image signal into a plurality of image regions in which each image region has a plurality of pixels;
a computing unit, coupled to the detector and the determining unit, for computing statistic data for each of the image regions according to results of the predetermined detection to obtain a plurality of statistic data corresponding to the image regions;
a display apparatus, having a backlight module, for displaying the picture; and
a controlling unit, coupled to the computing unit and the backlight module, for controlling a portion of the backlight module corresponding to a specific image region according to statistic data for the specific image region of the image regions.

22. The image display system of claim 21, wherein the determining unit determines the image regions according to the results of the predetermined detection.
